(19) United States
(12) Patent Application Publication
(10) Pub. No.: US 2012/0199130 A1
(43) Pub. Date: Aug. 9, 2012

(54) HYGIENIC MASK FOR AIRCRAFT CREWMEMBER AND A MASK ASSEMBLY COMPRISING THE HYGIENIC MASK

(76) Inventors: Guillaume Euvrard, Fontenay-Le-Fleury (FR); Yannick Chevalier, St. Dennis De Cabanne (FR); Christophe Barreau, Treigny (FR); Severine Thenault-Aubonnet, Fontenay-Le-Fleury (FR)

(21) Appl. No.: 13/502,182

(22) PCT Filed: Oct. 20, 2010
(86) PCT No.: PCT/EP10/65832

§ 371 Date: Apr. 16, 2012

(30) Foreign Application Priority Data
Oct. 21, 2009 (IB) PCT/IB2009/055228

(51) Int. Cl. A62B 18/02; A62B 23/00; A62B 18/08

(52) U.S. Cl. 128/206.17; 128/206.12

(57) ABSTRACT

Hygienic mask (1) for aircraft crewmember comprising a first area (3) made of an air filtering tissue and a second area (5) made of a flexible material, said second area (5) surrounding the first area (3) and being attached to the edge of said first area (3). The hygienic mask (1) comprises an air filter (43) including the second area (5) and a retaining element (70) including the first area (3), and the air filter (43) is removably fixed directly to the retaining element (70).

### FIELD OF THE INVENTION

The invention relates to the field of hygienic mask for aircraft crewmember and to a mask assembly comprising the hygienic mask. Specifically, the invention relates to hygienic mask compatible with respiratory protection mask for aircraft and in particular with respiratory protection mask with on-demand regulator.

### BACKGROUND OF THE INVENTION

The respiratory protection masks used by civil airplane pilots to combat hypoxia in particular are part of the airplane and are used by several pilots in turn, particularly for tests or preventive uses of the masks. This causes a degree of physiological discomfort for the pilot and that is not without risk concerning certain infections transmissible through skin or the respiratory system.

### SUMMARY OF THE INVENTION

It would be advantageous to achieve a hygienic mask which takes into account the hygienic aspects of its use while maintaining the well-known reliability and easiness of use of today respiratory mask.

To better address one or more concerns, in a first aspect of the invention an hygienic mask for aircraft crewmember comprises:
a first area having an edge and being made of an air filtering tissue; and
a second area made of a flexible material, said second area surrounding the first area and being attached to the edge of said first area.

When the hygienic mask is worn by the crewmember, the first area has a shape adapted to cover at least the nose and the mouth of the crewmember and to fit into a face piece of an aircraft respiratory protection mask and the second area has a shape to be disposed between the crewmember skin and a seal face element of the aircraft respiratory protection mask, when the aircraft respiratory protection mask is donned by the crewmember on top of the hygienic mask.

The hygienic mask has the advantage to isolate the aircraft respiratory protection mask from the skin and breathe of the crewmember and, at the same type, by its form adapted to the respiratory mask, to guarantee the airtightness and the comfort.

Furthermore, the hygienic mask can be easily donned on the respiratory mask and removed from the respiratory mask.

According to the invention, preferably the hygienic mask comprises an air filter including the second area and a retaining element including the first area, and the air filter is removably fixed directly to the retaining element.

Therefore, the air filter can be frequently changed to keep its efficiency whereas the retaining element is used for a longer period. Otherwise, the hygienic mask forms a single part, even when removed from the respiratory mask. So, it is easier to remove the hygienic mask from the respiratory mask and it is easier to carry. Furthermore, the risk that spit, bacteria or the like which are on a face of the hygienic mask contact the other face of the hygienic face during carrying up to a trash is reduced.

According to the invention, the hygienic mask preferably further has the following features:
the retaining element is a skirt having a hole, a fixing area and the second area,
the fixing area is rigid and extends around the hole,
the second area extends around the fixing area, and
the air filter is disposed in the hole and fixed to the fixing area.

Therefore, the fixation of the air filter on the retaining element is easier while the seal between the second area and the crewmember's skin and the comfort art maintained or increased.

The invention further relates to a mask assembly comprising said hygienic mask and an aircraft respiratory protection mask comprising a face piece having a breathing cavity. The first area fits into the face piece and has a shape adapted to cover at least the nose and the mouth of said crewmember and, the second area has a shape to be disposed between a seal face element of the face piece and the crewmember skin, when said aircraft respiratory protection mask is donned by said crewmember on said hygienic mask.

In advantageous embodiments, the breathing assembly preferably further has one or more of the features mentioned in the appended claims.

A particular embodiment may be preferred as easier to adapt or as giving a better result. Aspects of these particular embodiments may be combined or modified as appropriate or desired, however.

### BRIEF DESCRIPTION OF THE DRAWINGS

These and other aspects of the invention will be apparent from and elucidated with reference to the embodiment described hereafter where:

FIG. 1 is a schematic view of a first embodiment of an hygienic mask;

FIG. 2 is schematic view of a mask assembly comprising the first embodiment of hygienic mask shown in FIG. 1 mounted on a respiratory mask positioned on an user's face;

FIG. 3 is a partial schematic view of a second embodiment;

FIG. 4 is a schematic cross section of a mask assembly according to a third embodiment;

FIGS. 5A, 5B, 5C are schematic views of the mounting of the hygienic mask according to the third embodiment shown in FIG. 4 on the respiratory mask;

FIG. 6 is an exploded perspective view of a hygienic mask according to a fourth embodiment;

FIG. 7 is a cross sectional view of a mask assembly comprising the first embodiment of hygienic mask shown in FIG. 6 mounted on a respiratory mask positioned on an user's face.

### DETAILED DESCRIPTION OF THE EMBODIMENTS

Identical or similar elements keep the same reference number in all the figures.

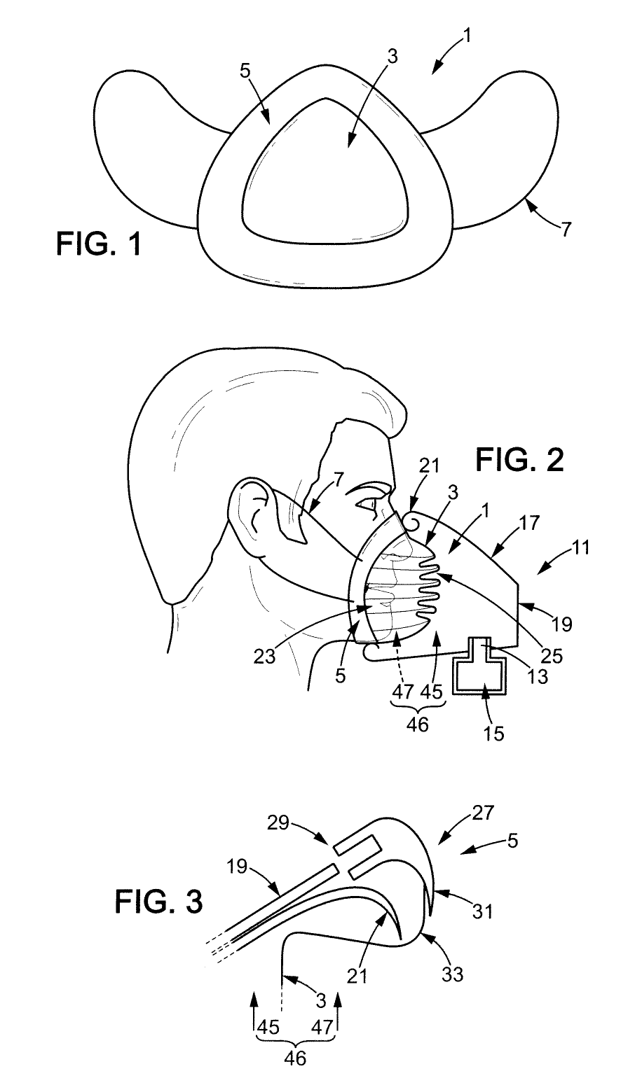

In a first embodiment, a hygienic mask 1 for aircraft crewmember comprises, FIG. 1, a first area 3 made of a filtering material, usually called an air filtering tissue, and a second area 5 made of a flexible material. The second area 5 is surrounding the first area and is attached to the edge of the first area in an airtight manner so that air can only cross the hygienic mask 1 through the filtering tissue of the first area 3.

A fixation device 7 is bonded on the second area for attaching the hygienic mask on the face of a crewmember.

When the hygienic mask 1 is worn by the crewmember, the first area 3 has a shape adapted to cover at least the nose and the mouth of the crewmember.

A regulator mask 11 for crewmember of an aircraft comprises, FIG. 2, a face piece 17 and an on-demand regulator 15 for providing respiratory gas to the crewmember. The on-demand regulator 15 is provided in respiratory gas from a breathing source (not represented). Otherwise, the on-demand regulator 15 is in fluid communication with the face piece 17 through a supply duct 13. The face piece 17 has a form adapted for creating an airtight volume 46 defining a breathing cavity when the regulator mask 11 is donned by the user. The airtight volume 46 is in communication with the on-demand regulator through the supply duct 13. Consequently, the user breathes in the respiratory gas supplied by the on-demand regulator 15 into the airtight volume 46 and is protected from hypoxia or smokes or other dangerous gas that may exist around him/her by the regulator mask 11.

For creating the airtight volume 46, the face piece 17 comprises a rigid part 19 rigidly connected to the on-demand regulator 15 and a semi-flexible seal face element 21 having a form adapted to the face of the user for creating an airtight join between the seal face element 21 and the face. The seal face element 21 is preferably a part of the face piece 17 and integral with the rigid part 19. Often, the seal face element is made of latex, polyurethane or silicone. When the crewmember dons the regulator mask 11 on top of the hygienic mask 1, the first area 3 fits into the face piece 17 of the regulator mask and the second area 5 has a shape to be disposed between the crewmember skin 9 and the seal face element 21 of the regulator mask. The flexibility of the second area 5 is at least equal to the flexibility of the seal face element 21 so that the interface between the hygienic mask and the user skin 9, and the interface between the hygienic mask and the seal face element are airtight. As it is well known from the man skilled in the art, the regulator mask 11 is maintained in place by a harness (not shown) which presses the regulator mask on the user face. So the second area 5 needs to be flexible enough to model itself on the user face when pressed by the regulator mask.

The second area 5 has thus preferably a thickness t of less than 0.8 mm and may be made of electrostatic material and/or polymeric material distortable at the human body temperature. For instance, the second area is preferably made of thermoplastic elastomer and may also be made of silicone, latex or polyurethane. Or the second area may be made of the same material as the first area but disposed differently for achieving the different purposes.

The first area 3 comprises reinforcements 23 to maintain the first area at a distance of the crewmember mouth greater than a predetermined value. For the comfort of the crewmember, the hygienic mask has the advantage to be as imperceptible as possible by not restricting mouth movements.

The first area 3 comprises also some folds 25 to increase the surface of the filtering tissue and to diminish thus the air flow reduction generated by the hygienic mask whilst staying in the volume of the face piece 17.

In the second embodiment, FIG. 3, the second area 5 is resilient and comprises a lip element 27 which comprises a fixation area 29. The lip element 27 is fixed onto the rigid part 19 of the regulator mask 11 by the fixation area 29. The lip element 27 further has a seal area 31 intended to be positioned between the user's skin 9 and an edge of the face piece defining a regulator mask seal face element 21. A flexible and airtight foil 33 is disposed between the lip element 27 and the first area 3 to which it is attached. A tab fixed on the lip element 27 may be provided to help the user to separate the lip element 27 from the regulator mask 11.

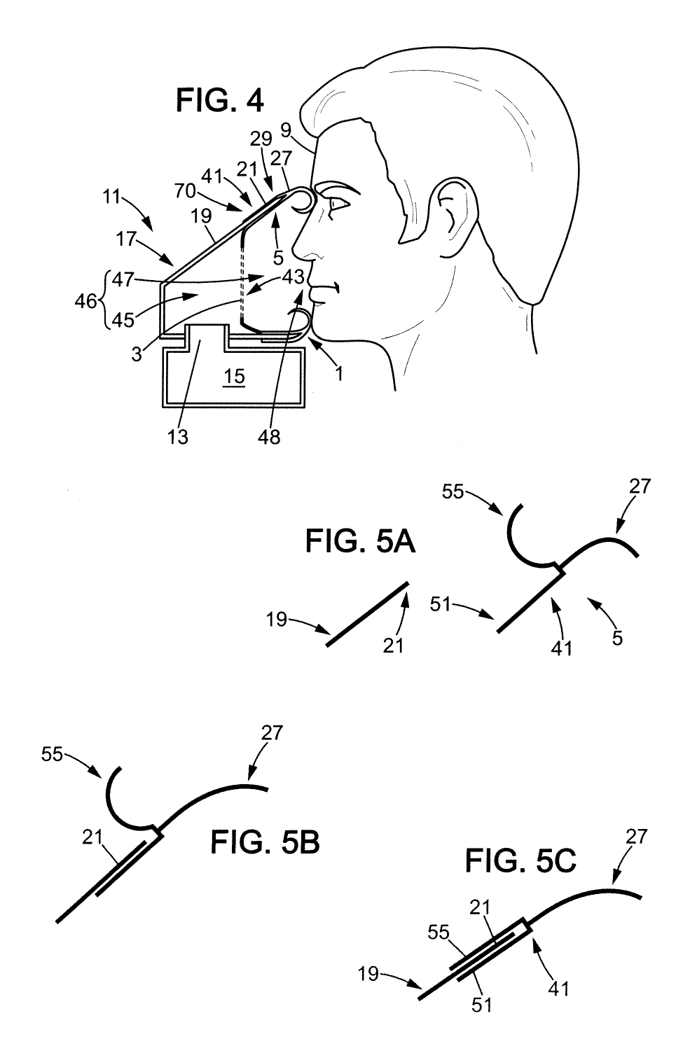

In reference to FIG. 4, according to the third embodiment, the rigid part 19 and the lip element 27 are separated parts attached together in an airtight manner by a releasable fixation device 41.

The releasable fixation device 41 has the advantage to allow the easy separation of the lip element 27 of the second area 5 of the hygienic mask 1 from the regulator mask 11 and in particular the rigid part 19 of the face piece 17. Consequently, the lip element 27 and more generally the hygienic mask 1 may be cleaned up easily and/or coated with an antibacterial coating and, for instance, a new and clean lip element 27 may be installed each time a new crewmember has to use the respirator mask. The lip element 27 may also be modeled to the face of a particular user: the user keeps it with his/her own belongings and installs it on a respirator mask that he/she is going to use. Or the hygienic mask 1 may exist with the lip element 27 in different standardized sizes, the user choosing the size which fits best its face.

Consequently, the regulator mask according to this embodiment is perfectly hygienic in the sense that the part contacting the user skin 9 is clean and the interface between the lip element 27 and the skin 9 is airtight, guaranteeing the same level of efficiency as the standard regulator mask well known from the man skilled in the art.

To increase the hygienic aspect, the first area 3 is provided with an air filter 43. It separates the airtight volume 46 in two separate volumes, a first volume and a second volume 47. The second volume extends between the hygienic mask and an opening 48. The mouth and the nose of the user are received in the opening 48 and directly communicate with a second volume 47 whereas the first volume 45 directly communicates with the supply duct 13. The first volume 45 and the rigid part 19 are isolated from the user's face. Therefore, the user breathes in the respiratory gas coming in the second volume 47 connected to the on-demand regulator 15 through the air filter 43. At the same time, the air filter 43 protects the rigid part 19 from any particles generated by the user such as spray of spit, bacteria, etc. The air filter 43 of the first area 3 of the second embodiment of FIG. 4 has thus the same function as the first area of the first embodiment of FIG. 1.

The first area 3 may be integral with the second area 5 or a separate component. If the hygienic mask 1 is manufactured to be a disposable component, it is advantageous that the first area 3 and the second area 5 be included in a single component to minimize the number of parts and to simplify the mounting of hygienic mask 1 comprising the lip element 17 and the filter 43 onto the rigid part 19 of the regulator mask.

At the opposite, if the lip element 27 is specifically tailored to a particular user with the aim to be usable on a longer period of time, it is advantageous to separate the filter 43 which needs to be changed frequently to keep its efficiency. Therefore the hygienic mask comprises the air filter 43 including the first area 3 and a retaining element 70 comprising the second area 5, the air filter 43 being releasably fixed to the retaining element 70.

As illustrated in FIGS. 5A, 5B and 5C, an edge portion of the rigid part 19 defines the seal face element and in the fixation area 29 the second area 5 has a U-form section and comprises a first surface 51 formed to fit together with the seal face element 21 of the rigid part 19 and a flexible second surface 55 for covering an external surface of the seal face element 21 of the rigid part 19. FIG. 5A illustrates the rigid part 19 and the hygienic mask 1 when they are separated. To prepare the installation of the hygienic mask 1, the user bends back the flexible second surface 55, FIG. 5A, and approaches the hygienic mask 1 to the seal face element 21 of the rigid part 19 until the first surface 51 fits with the seal face element 21 of the rigid part 19, FIG. 5B. Then, the second surface 55 is resiliently returned to its initial position to cover the external surface of the rigid part 19. The seal face element 21 is thus pinched by the two surfaces 51, 55 of the second area 5 to create an airtight seal. As the rigid part 19 is substantially cone-shaped, the hygienic mask 1 is also maintained attached to the rigid part 19 of the face piece 17.

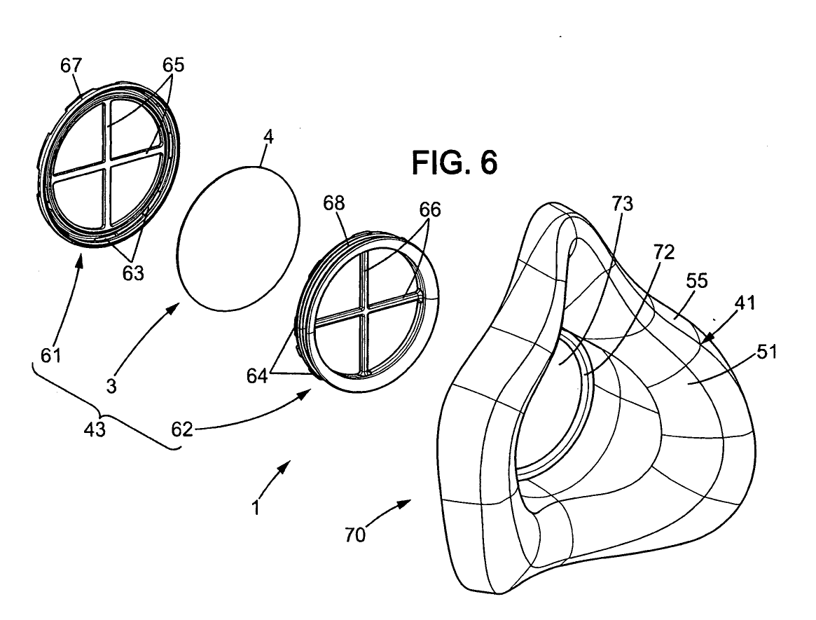

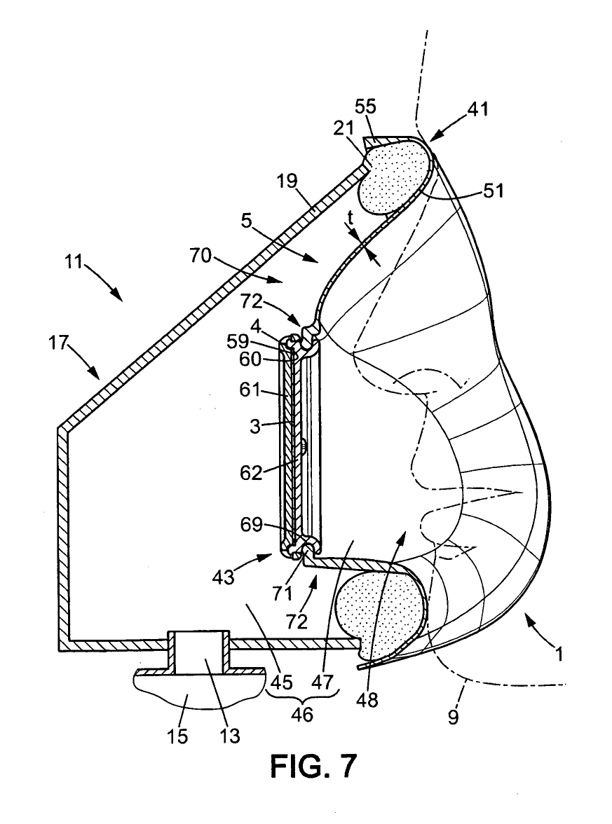

FIGS. 6 and 7 illustrate a fourth embodiment. In this fourth embodiment, the hygienic mask 1 is donned on a respiratory mask 11 mainly comprising the face piece 17 and the on-demand regulator 15 provided in respiratory gas from the breathing source (not represented). The hygienic mask 1 mainly comprises an air filter 43 including the first area 3 and a retaining element 70 including the second area 5.

The retaining element 70 defines a unitary skirt having the second area 5 and a fixing area 72 extending around a hole 73. The fixing area 72 is substantially rigid (more rigid than the second area 5) and includes a collar having an annular rib 71 which radially protrudes, towards the hole 73.

The second area 5 extends around the fixing area 72, is flexible and includes a peripheral releasable fixation portion 41. The thickness t (indicated in FIG. 7) of the second area 5 is preferably lower than 0.8 millimetre and the second area 5, in particular the releasable fixation portion 41, is preferably resilient. The retaining element 70 is preferably a single part and the whole retaining element 70 is preferably made of thermoplastic elastomer. It may also be made in particular in silicone, latex or polyurethane, and preferably in the same material. Moreover, the retaining element 70 is preferably made of electrostatic material and/or polymeric material distortable at the human temperature.

The releasable fixation portion 41 has a U-form section and comprises an internal surface 51 and an resilient external surface 55 between which is received the seal face element 21 of the face piece 17. The seal face element 21 is thus pinched by the two surfaces 51, 55 of the releasable fixation portion 41 to create an airtight seal. The hygienic mask 1 is also maintained attached to the rigid part 19 of the face piece 17 due to the substantially cone-shape of the face piece 17. The seal face element 21 illustrated in the fourth embodiment is preferably a peripheral roll in resilient and/or expanded material and is fixed to the edge of the rigid part 19 of the face piece 17.

The donning of the releasable portion 41 of the fourth embodiment is similar as above described in connection with the third embodiment shown in FIGS. 5A, 5B and 5C.

The air filter 43 is disposed in the hole 73 and comprises the first area 3 and a support including a first shell 61 and a second shell 62. Each of the first shell 61 and the second shell 62 comprise a peripheral ring 67, 68 and two perpendicular cross bars 65, 66 extending radially in the hole 73.

The first area 3 is a flat disk having a circular edge 4. The cross bars 65 of the first shell in disposed on a first side of the first area 3 and the cross bars 66 are disposed on a second side (opposite the first side) of the first area 3. So, the first area 3 is maintained between the bars 65 of the first shell 61 and the bars 66 of the second shell 62. Furthermore, the rings 67, 68 of each of the first shell 61 and the second shell 62 comprise an annular protrusion (bead) pressing on each side of the edge 4 of the first area to sealingly maintain said edge 4 of the first area 3 to the support defined by the first shell 61 and the second shell 62.

The first shell 61 further comprises a plurality of housings 63 and the second shell 62 further comprises a plurality of tongues 64 complementary to the housings 63.

The tongues 64 are inserted in the housings 63 by snapping action. Preferably all the air filter 43 is changed, but in a variant the first shell 61 could be releasably fixed to the second shell 62, so that the user could separate the first shell 61 from the second shell 62, change the first area 3, place a new first area 3 between the first shell 61 and the second shell 62, and fix them again thanks to the snapping elements 63, 64.

The second shell 62 further comprises a peripheral annular groove 69 in which is sealingly received the annular rib 71 of the collar 72. Therefore, the air filter 43 is directly fixed to the collar 72 by clipping action and can be easily released to change the whole air filter or only the first area 3 of the air filter 43 as specified above.

As shown in FIG. 6, the face piece 17 has an airtight volume 46 in communication with the on-demand regulator 15 through the supply duct 13 and with the venting orifices of the user through the opening 48 in which is received the face 9 of the crewmember.

The hygienic mask 1 partitions the airtight volume into the first volume 45 and the second volume 47. Therefore, the hygienic mask 1 isolates the first volume 45 from the second volume 47. The mouth and the nose of the user directly communicate with the second volume 47 by the opening 48 whereas the first volume 45 directly communicates with the supply duct 13.

Therefore, the first volume 45 communicates with the second volume 47 only through the first area 3 of the hygienic mask 1. So, the face piece 17, the supply duct 13 and the regulator 15 are prevented from contamination contained in the air exhaled by the user, thanks to the hygienic mask 1.

Moreover, only the second area 5 of the hygienic mask 1 is in contact with the face piece 17 and the first area 3 is away from face piece 17. Otherwise, the second area 5 is only in contact with the seal face element 21 of the face piece 17 and away from the rigid part 19 of the face piece 17.

It should be noticed that the hygienic mask 1 is retained to the face piece 17 only by the cooperation between the releasable fixation portion 41 of the second area 5 and the seal face element 21 of the face piece 17 under pressure of the skin 9 of the user on the fixation portion 41.

The air filtering tissue of the first area 3 has preferably a high efficiency for filtering bacteria and a low resistance to the flow of air. It is advantageously a high efficiency particulate air (HEPA) filter composed of a mat of randomly arranged fibers. The fibers are typically composed of fiberglass, polyester felt, polypropylene felt or the like.

While the invention has been illustrated and described in details in the drawings and foregoing description, such illustration and description are to be considered illustrative or exemplary and not restrictive; the invention is not limited to the disclosed embodiment.

For instance, specific features may be used in other embodiments than the one in which they are disclosed. For instance, the fixation element 39 of FIG. 3 may use the fixation features disclosed in the third embodiment.

The respiratory protection mask may be an on-demand regulator mask or a continuous oxygen flow mask. The man skilled in the art understands that the invention is not specific to one of these types of respiratory protection mask.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality, unless otherwise specified or excluded for technical reason.

1. Hygienic mask for aircraft crewmember comprising:
an air filter including a first area, said first area having an edge and being made of an air filtering tissue; and
a retaining element having a hole, a fixing area and a second area
the air filter being disposed in the hole and removably fixed directly to the fixing area,
the fixing area extending around the hole,
the second area extending around the fixing area
wherein the fixing area is rigid and the retaining element is a skirt the second area being made of a flexible material.

2. (canceled)

3. (canceled)

4. Hygienic mask according to claim 1 wherein the fixing area comprises a collar and the air filter comprises a support which supports the first area and is directly fixed to the collar of the skirt.

5. Hygienic mask according to the 2 wherein the support comprises a first shell and a second shell between which the first area is maintained.

6. Hygienic mask according to claim 3 wherein the air filter further comprises snapping elements fixing the first shell and the second shell one to the other.

7. Hygienic mask according to claim 3 wherein the first shell and the second shell comprise bars extending on each side of the first area, across the hole.

8. Hygienic mask according to claim 3, wherein each of the first shell and the second shell comprises a ring and at least two cross bars.

9. Hygienic mask according to claim 3 wherein the support second shell comprises an annular groove in which the collar is sealingly received.

10. Hygienic mask according to claim 1 wherein the whole skirt is made of thermoplastic elastomer.

11. Hygienic mask according to claim 1 wherein the second area comprises a peripheral releasable fixation portion having a U-form section.

12. Hygienic mask according to the CLAIM 9 wherein the peripheral releasable fixation portion comprises a first surface and a second surface intended to pinch an edge of a face piece.

13. Hygienic mask according to claim 1, wherein said second area has a thickness of less than 0.8 mm.

14. Hygienic mask according to claim 1, wherein said second area is made of an electrostatic material.

15. Hygienic mask according to claim 1, wherein said second area is made of a polymeric material distortable at the human body temperature.

16. Hygienic mask according to claim 1, wherein said first area comprises reinforcements to maintain said first area at a distance of the crewmember mouth greater than a predetermined value.

17. Hygienic mask according to claim 1, wherein the attachment of the second area to the first area is airtight.

18. Hygienic mask according to claim 1, wherein the first area and the second area comprise the same material.

19. Hygienic mask according to claim 1, wherein the hygienic mask further comprises a fixation device for attaching said hygienic mask on a crewmember's face.

20. Hygienic mask according to claim 1, wherein the second area further comprises a lip element for being in contact with a crewmember's face and a fixation area for attaching said hygienic mask onto an aircraft respiratory protection mask.

21. Mask assembly comprising:
an hygienic mask according to CLAIM 1,
a aircraft respiratory protection mask comprising a face piece having a breathing cavity,
wherein the first area Fits into the face piece and has a shape adapted to cover at least the nose and the mouth of said crewmember and, the second area has a shape to be disposed between a seal face element of the face piece and the crewmember skin, when said aircraft respiratory protection mask is donned by said crewmember on said hygienic mask.

22. Mask assembly according to claim 19 wherein the first area of the hygienic mask is disposed in the breathing cavity of the face piece and the second area is in airtight contact with the face piece.

23. Mask assembly according to claim 19, wherein the second area of the hygienic mask is removably connected to the face piece.

24. Mask assembly according to claim 19 wherein:
the face piece has an internal cavity,
the mask assembly further comprises a supply duct and an opening intended to receive an aircraft crewmember face to deliver breathing gas to the aircraft crewmember,
the hygienic mask partitions the internal cavity into a first volume and a second volume,
the first volume directly communicates with the supply duct, and
the opening directly communicate with the second volume,
the first volume communicates with the second volume through the first area of the hygienic mask.

25. Mask assembly according to claim 19 wherein the second area comprises a peripheral releasable fixation portion having a U-form section.

26. Mask assembly according to claim 23 wherein the peripheral releasable fixation portion comprises an internal surface and a flexible external surface pinching an edge of the face piece.

27. Mask assembly according to claim 19, wherein the second area has a flexibility at least equal to the flexibility of said seal face element so that, when the aircraft respiratory protection mask is donned on top of said hygienic mask, the interface between the hygienic mask and the user skin and the interface between the hygienic mask and the seal face element are airtight.
